(19) United States
(12) Patent Application Publication
(10) Pub. No.: US 2025/0079149 A1
(43) Pub. Date: Mar. 6, 2025

(54) ULTRAVIOLET CATHODOLUMINESCENT LAMP, SYSTEM AND METHOD

(71) Applicant: NS Nanotech, Inc., Ann Arbor, MI (US)

(72) Inventors: Seth COE-SULLIVAN, Rolling HIlls Estates, CA (US); Matthew STEVENSON, Chelsea, MI (US); David Arto LALEYAN, Pierrefonds (CA)

(21) Appl. No.: 18/955,699

(22) Filed: Nov. 21, 2024

Related U.S. Application Data
(63) Continuation of application No. PCT/US2023/023315, filed on May 24, 2023.
(60) Provisional application No. 63/345,399, filed on May 24, 2022.

(51) Int. Cl. H01J 63/06; H01J 63/02

(52) U.S. Cl. CPC H01J 63/06; H01J 63/02

(57) ABSTRACT

A cathodoluminescent lamp includes a filament configured to emit electrons responsive to a voltage applied across the filament, an anode configured to receive electrons emitted from the filament, an emitter comprising cathodoluminescent material, disposed in proximity to the anode, configured to emit photons responsive to stimulation from the electrons and a vacuum envelope configured to enclose the filament, anode, and emitter, and to maintain a vacuum over a path of the electrons. The filament comprises a smooth electron emitting surface. The cathodoluminescent material may comprise a semiconductor material.

### CROSS-REFERENCE TO RELATED APPLICATIONS

The present application is a Continuation of PCT Application No. PCT/US2023/023315 filed May 24, 2023, which claims priority to U.S. Provisional Application 63/345,399 (Attorney Docket TRTM-0019-00.00US), filed May 24, 2022, entitled “Ultraviolet Cathodoluminescent Lamp, System and Method,” to S. Coe-Sullivan et al., both of which are hereby incorporated herein by reference in their entirety.

This application is related to the application entitled “Ultraviolet Field-Emission Lamps and Their Applications,” by S. Coe-Sullivan et al., U.S. patent application Ser. No. 17/195,438, filed Mar. 8, 2021, and to the application entitled “Synthesis and Use of Materials for Ultraviolet Field-Emission Lamps,” by S. Coe-Sullivan et al., U.S. patent application Ser. No. 17/009,621, filed Sep. 1, 2020, both of which claim priority to U.S. Provisional Application entitled “Synthesis and Use of Materials for Ultraviolet Field-Emission Lamps, and Ultraviolet Field-Emission Lamps and Their Applications,” by S. Coe-Sullivan et al., U.S. Provisional Patent Application No. 63/071,810, filed Aug. 28, 2020, all of which are hereby incorporated herein by reference in their entireties.

### BACKGROUND OF THE INVENTION

The use of ultraviolet light, e.g., for disinfection, has become an area of significant interest. Conventional emitters may produce ultra-violet (UV) light in the approximate range of 200-230 nanometers, a range which is germicidal but essentially harmless to human skin and eyes.

One way to achieve a cathodoluminescence effect is by the use of field-emission devices, in which electrons are extracted from the cathode and accelerated towards the emitter to produce cathodoluminescence. The cathode for such devices typically consists of an array of sharp points at which the electric field is concentrated, allowing for easy extraction of electrons. Examples include carbon nanotubes, reticulated vitreous carbon (RVC), and Spindt tip arrays. Unfortunately, such field-emission devices are complex, prohibitively expensive to manufacture, and oftentimes suffer from unacceptably short lifetimes. For example, Spindt tip arrays are generally made by the nanopatterning of semiconductor materials, and while functional, such devices are prohibitively expensive for a consumer device. Field emitters using RVC or carbon nanotubes generally suffer from deleteriously short lifetimes, e.g., less than about five hours.

Conventional vacuum tubes are generally not suitable for producing and/or emitting light in the spectrum of interest, e.g., 200-230 nanometers, because the conventional vacuum envelope materials, e.g., glass and/or metal, are not sufficiently transparent at these wavelengths.

### SUMMARY OF THE INVENTION

Embodiments according to the present invention provide a solution to the problems described above.

What is needed are ultraviolet lamps based on cathodoluminescent material that do not require the use of a field emitter type cathode. What is additionally needed are ultraviolet lamps based on cathodoluminescent material comprising an anode configured to reflect light form an emitter out of the device. What is further needed are ultraviolet lamps based on cathodoluminescent material comprising a vacuum envelope transparent to ultraviolet light. There is a still further need for systems and methods for ultraviolet lamps based on cathodoluminescent material that are compatible and complementary with existing systems and methods of ultraviolet lamps.

Embodiments in accordance with the present invention utilize thermionic emission of electrons from a hot filament as an electron source and then accelerates such electrons via a strong electric field to produce the desired cathodoluminescence from the emissive material. This approach offers several advantages over the conventional art. In accordance with embodiments of the present invention, the materials of construction are easier and less expensive to obtain than carbon nanotubes, RVC, or Spindt tip arrays, which are often custom made at this time. The disclosed filament materials can have a desirably long operating lifetime that satisfies the requirements for a commercial product.

In accordance with embodiments of the present invention, a cathodoluminescent lamp includes a filament configured to emit electrons responsive to a voltage applied across the filament, an anode configured to receive electrons emitted from the filament, an emitter comprising cathodoluminescent material, disposed in proximity to the anode, configured to emit photons responsive to stimulation from the electrons and a vacuum envelope configured to enclose the filament, anode, and emitter, and to maintain a vacuum over a path of the electrons. The filament comprises a smooth emitting surface.

Embodiments include the above and further include wherein the photons have a wavelength in a range of 200-230 nanometers (nm).

Embodiments include the above and further include wherein the anode is configured to reflect light from the emitter out of the device.

Embodiments include the above and further include wherein a portion of the vacuum envelope is transparent to the photons.

Embodiments include the above and further include wherein the lamp is configured to emit the photons though the same side as the filament.

Embodiments include the above and further include wherein the lamp is configured to apply a voltage of at least 1 kV between the anode and the cathode.

Embodiments include the above and further include wherein the filament is configured to operate at a temperature of greater than 1800 K.

Embodiments include the above and further include filament contacts, wherein the filament contacts comprise a thermally conductive material and have sufficient mass to act as a heat sink for the filament.

Embodiments include the above and further include wherein the emitter is coated upon the anode.

Embodiments include the above and further include a cap, configured to act as the anode, configured to physically support the emitter, and configured to reflect the photons.

Embodiments include the above and further include a control grid electrode disposed between the anode and the filament, configured to control a flow of electrons from the cathode to the anode.

Embodiments include the above and further include wherein the control grid is further configured to direct a flow of electrons to an area of the anode.

Embodiments include the above and further include a spacer tube configured to electrically insulate and physically separate the anode from the cathode, wherein the spacer tube is further configured to withstand a voltage greater than 1 kV.

Embodiments include the above and further include a faceplate forming at least a portion of the vacuum envelope, and wherein the faceplate is transparent to the photons.

Embodiments include the above and further include wherein the filament has a coil shape.

Embodiments include the above and further include wherein the filament has an arc shape.

Embodiments include the above and further include wherein the filament has a line shape.

Embodiments include the above and further include wherein the filament has a loop shape.

Embodiments include the above and further include wherein the filament has a spiral shape.

Embodiments include the above and further include wherein the filament has a circular cross section.

Embodiments include the above and further include wherein the anode comprises a first material in contact with the emitter, wherein the first material is characterized as having good reflectivity for wavelengths in the range of 200-230 nm, and wherein the first material is further characterized as having a coefficient of thermal expansion greater than that of a spacer tube coupled to the anode.

Embodiments include the above and further include wherein the anode comprises a second material in contact with the first material and not in contact with the emitter, wherein the second material is characterized as having poor reflectivity for wavelengths in the range of 200-230 nm, and wherein the second material is further characterized as having a coefficient of thermal expansion that more closely matches that of the spacer tube in comparison to the first material.

Embodiments include the above and further include wherein an electrical resistance between the first and second materials is less than about 1 ohm.

Embodiments of the present invention include a thermionic device, comprising a vacuum envelope, configured to emit photons outside of the vacuum envelope in the wavelength range of 200-230 nm.

Embodiments of the present invention include a light emitting device, configured to emit photons in the wavelength range of 200-230 nm from a solid state semiconductor, having a stable light emission of greater than or equal to 0.10 mW for more than 50 hours.

Embodiments of the present invention include a light emitting device, configured to emit photons in the wavelength range of 200-230 nm from a solid state semiconductor, having a stable light emission of greater than or equal to 0.50 mW for more than 130 hours.

Embodiments of the present invention include a light emitting device, configured to emit photons in the wavelength range of 200-230 nm from a solid state semiconductor, having a stable light emission of greater than or equal to 50 μW for more than 700 hours.

### BRIEF DESCRIPTION OF DRAWINGS

The accompanying drawings, which are incorporated in and form a part of this specification and in which like numerals depict like elements, illustrate embodiments of the present disclosure and, together with the detailed description, serve to explain the principles of the disclosure. The drawings are not necessarily to scale.

FIG. 1 illustrates a high-level schematic of an exemplary cathodoluminescent light emitting device, in accordance with embodiments of the present invention.

FIG. 2 illustrates a schematic diagram of an exemplary inverted structure thermionic light emitting device, in accordance with embodiments of the present invention.

FIG. 3 illustrates a portion of an exemplary cathodoluminescent lamp comprising a grid electrode located between an anode and a filament/cathode, in accordance with embodiments of the present invention.

FIG. 4 illustrates several exemplary filament shapes, in accordance with embodiments of the present invention.

FIG. 5 illustrates an exemplary filament contact design, in accordance with embodiments of the present invention.

FIG. 6 illustrates a first exemplary graph of thermionic lamp output power vs. time, in accordance with embodiments of the present invention.

FIG. 7 illustrates a schematic diagram of an exemplary multi-piece cap structure, in accordance with embodiments of the present invention.

FIG. 8 illustrates a second exemplary graph of thermionic lamp output power vs. time, in accordance with embodiments of the present invention.

FIG. 9 illustrates a third exemplary graph of thermionic lamp output power vs. time, in accordance with embodiments of the present invention.

### DETAILED DESCRIPTION OF THE INVENTION

Reference will now be made in detail to the embodiments of the present technology, examples of which are illustrated in the accompanying drawings. While the present technology will be described in conjunction with these embodiments, it will be understood that they are not intended to limit the technology to these embodiments. On the contrary, the invention is intended to cover alternatives, modifications and equivalents, which may be included within the scope of the invention as defined by the appended claims. Furthermore, in the following detailed description of the present technology, numerous specific details are set forth in order to provide a thorough understanding of the present technology. However, it is understood that the present technology may be practiced without these specific details. In other instances, well-known methods, procedures, components, and circuits have not been described in detail as not to unnecessarily obscure aspects of the present technology.

The figures are not necessarily drawn to scale, and only portions of the devices and structures depicted, as well as the various layers that form those structures, are shown. For simplicity of discussion and illustration, only one or two devices or structures may be described, although in actuality more than one or two devices or structures may be present or formed. Also, while certain elements, components, and layers are discussed, embodiments according to the invention are not limited to those elements, components, and layers. For example, there may be other elements, components, layers, and the like in addition to those discussed.

As used herein the terms “cathodoluminescent” or “cathodoluminescence” refer to or describe materials and/or processes by which electrons stimulate materials to produce photons. These terms do not imply that such materials are or form an electrical cathode.

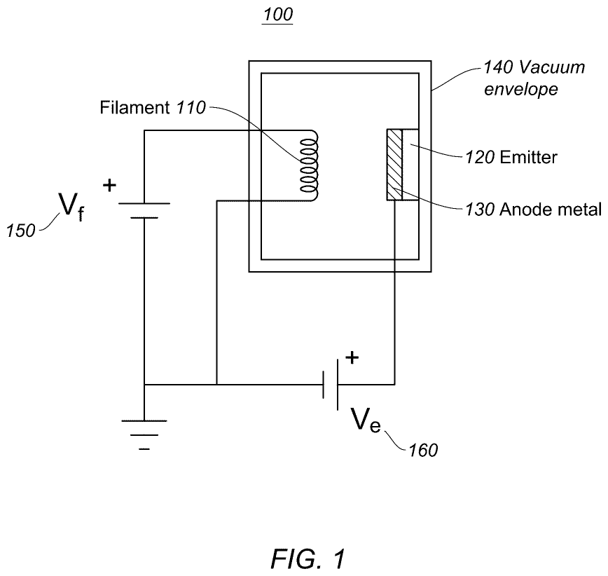

FIG. 1 illustrates a high-level schematic of an exemplary cathodoluminescent light emitting device 100, in accordance with embodiments of the present invention. Filament 110 provides a source of electrons in the system when heated. The heating may be accomplished by the application of a filament voltage Vf 150. The filament 110 also acts as the cathode of the device. In some embodiments, the heating of the electron-emitting filament may be accomplished by a separate heater.

In accordance with embodiments of the present invention, filament 110 does not operate as a field emitter type cathode. For example, filament 110 lacks “sharp” points and/or other features configured to concentrate an electrical field. Filament 110 may be formed from wire-like materials, in some embodiments. In some embodiments, filament 110 may have a circular cross section.

Emitter 120 comprises a layer of cathodoluminescent material which produces light from the energy of the electrons accelerated into it. Emitter 120 may have a smooth emitting surface, in accordance with embodiments of the present invention. Emitter 120 may comprise a semi-conductor material, in some embodiments. For example, emitter 220 is well-suited to a structure comprising hexagonal boron nitride (h-BN), as described in U.S. patent application Ser. No. 17/009,621, entitled “Synthesis and Use of Materials for Ultraviolet Field-Emission Lamps,” and incorporated herein by reference in its entirety, It is appreciated that emitter 120 is coupled to the anode 130, further described below. Electrically, emitter 120 is not a cathode.

Anode 130 forms an electrical contact for the emitter which allows for the application of the emitter voltage Ve 160, which extracts the electrons from the filament and accelerates them into the emitter 120. The electrons need to travel through this anode to reach the emitter, and the anode layer also needs to be reflective enough to direct emission from the emitter out of the system, so the thickness of the anode 130 is critical.

Vacuum envelope 140 provides a vacuum, e.g., a pressure less than or equal to 10-5 Torr, necessary for operation of the system 100. At least a portion of vacuum envelope 140 is transparent to light wavelengths of interest, e.g., ultraviolet light, or far-ultraviolet-C (far-UVC) light, in order to allow for the emitted light to pass through the vacuum envelope 140 material. Vacuum envelope 140 may comprise glass as in a vacuum tube, in some embodiments.

Although device 100 has three electrical connections: filament 110, anode metal 130, and ground. Device 100 may be referred to as a “diode structure” based on the basic electrical characteristics of the active portions of the device 100.

The device 100 operates by heating the filament 110, via the application of filament voltage Vf 150, to a temperature suitable for the thermionic emission of electrons. This voltage can vary based on the characteristics of the filament material used, the desired flux of electrons, and any desired limitation of blackbody emission from the filament. The cathodoluminescence of the emissive material is achieved by accelerating the emitted electrons via an applied field, induced by emitter voltage Ve 160, which causes the emitted electrons to bombard the emitter 120, where their energy is converted into the light that is emitted from the emitter 120 via cathodoluminescence. Emitter 120 may comprise many types of emissive materials, depending on the desired spectral characteristics of the emission, in accordance with embodiments of the present invention.

The device 100 can advantageously provide ultra-violet (UV) light that can be utilized to decontaminate, disinfect and the like, humans, vehicles and the like. The cathodoluminescent UV light is germicidal but essentially harmless to human skin and eyes. The UV light can for example be utilized as a disinfectant in scientific applications. In other applications, the cathodoluminescent UV light generated by the device 100 can be utilized to decontaminate vehicles including but not limited to ambulances, firefighting apparatus, school buses, public transportation buses, private charter buses, trains, planes, ride shares and taxis.

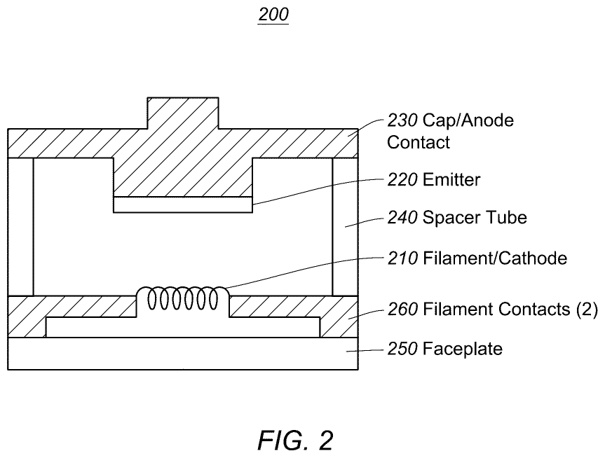

FIG. 2 illustrates a schematic diagram of an exemplary inverted structure thermionic light emitting device 200, in accordance with embodiments of the present invention. In order to allow for flexibility in use of emissive materials and materials of construction, it may be desirable to construct the device in an inverted manner, as illustrated in FIG. 2. In accordance with embodiments of the present invention, the light is emitted though the same side as the filament, so the electrical connection to the emitter can be a solid metal block as opposed to the thin layer described in the previous section. This makes the construction of this contact much less demanding, and allows the anode to act as a heat sink device.

FIG. 2 illustrates the optional addition of a separate faceplate 250, which may be employed as part of a vacuum envelope, e.g., vacuum envelope 140 (FIG. 1), if a glass vacuum envelope lacks sufficient transparency to a desired wavelength range. For example, if the emitted light is in the far ultraviolet “C” (far-UVC) region, then an ultraviolet fused silica (UVFS) faceplate may be employed, as a glass envelope typically is not transparent at these wavelengths. Additionally, fused silica doesn't lend itself to being formed into a complete envelope easily. A low-outgassing, vacuum-compatible adhesive may be used to join a UVFS faceplate to a glass envelope. One exemplary adhesive is Torr Seal® Low Vapor Pressure Epoxy, commercially available from Kurt J. Lesker Company, Jefferson Hills, PA. Alternatively, a UVFS faceplate may be joined to a metal envelope via brazing. Such vacuum components are commercially available from MDC Vacuum Products, Hayward, CA.

Filament 210 acts as a source of electrons for the device 200 when heated. Filament 210 electrically functions as a cathode of the device 200. There are a variety of materials that may be applicable to embodiments in accordance with the present invention. Suitable materials may include, for example, tungsten, thoriated tungsten, carburized thoriated tungsten, rheniated tungsten, iridized tungsten, barium, barium oxide, scandium, scandium oxide, tantalum, and molybdenum.

Emitter 220 comprises cathodoluminescent material that is the source of photons emitted by the device 200. In accordance with embodiments of the present invention, emitter 220 may comprise a wide variety of cathodoluminescent materials, which may, for example, include phosphor materials operating from the UV to the near infrared (NIR) range, and may comprise specially designed semiconductor systems that emit in the far-UVC region, for example. For example, emitter 220 is well-suited to a structure comprising hexagonal boron nitride (h-BN), as described in U.S. patent application Ser. No. 17/009,621, entitled “Synthesis and Use of Materials for Ultraviolet Field-Emission Lamps,” and incorporated herein by reference in its entirety, Care should be taken to adjust the materials of construction used in the device 200 (the faceplate, for example) to accommodate the emission wavelength(s) of interest.

In accordance with embodiments of the present invention, the emitter 220 is coated upon the cap/anode contact 230, which enables the cap/anode 230 to act as a reflector to direct the emitted light out of the device. The cap/anode 230 is the anode of the system 200, and is held at a high voltage relative to the filament as previously described.

The cap 230 may have multiple functions. The cap 230 acts as an electrical component of the device, e.g., as an anode, as a physical support for the emitter layer, and as a reflector of the light emitted from the emitter layer. As an electrical component, it is desirable that the cap material be electrically conductive; as a support material it is desirable that it be thermally conductive. Exemplary materials include aluminum, copper, Kovar™, Invar, and stainless steels. As a reflector, it is desirable that the cap 230 have significant reflectivity in the wavelength range of interest for the emitter. For the UV-C range, aluminum shows the highest reflectivity of commonly available metals, but other materials may also have desirable, e.g., greater than 90%, reflectivity in that wavelength range.

Spacer tube 240 is an electrically insulating tube that separates the anode 230 and cathode 210 of the system sufficiently to allow the application of a high voltage, e.g., a voltage greater than 1 kV, between the anode 230 and cathode 210.

Faceplate 250 comprises a material with high transmissivity in the desired wavelength range. For an exemplary UV-C emitter, UV-grade fused silica is a good material for the faceplate 250.

Device 200 comprises two filament contacts 260. The filament needs to be electrically connected to the device, which is accomplished in this example by attaching it to electrically conductive contacts. One of filament contacts 260 is connected to ground, while the other filament contacts 260 is used to provide power to the filament.

In accordance with embodiments of the present invention, addition of a properly designed electrode between the filament, e.g., filament 210, and the emissive material, e.g., emitter 220, which is known as or referred to as a ‘grid’ or ‘control grid,’ may improve operation of a cathodoluminescent lamp.

The thermionic light emitting device 200 can advantageously provide ultra-violet (UV) light that can be utilized to decontaminate, disinfect and the like, humans, vehicles and the like. The UV light can for example be utilized as a disinfectant in scientific applications. In other applications, the UV light generated by the thermionic light emitting device 200 can be utilized to decontaminate vehicles including but not limited to ambulances, firefighting apparatus, school buses, public transportation buses, private charter buses, trains, planes, ride shares and taxis.

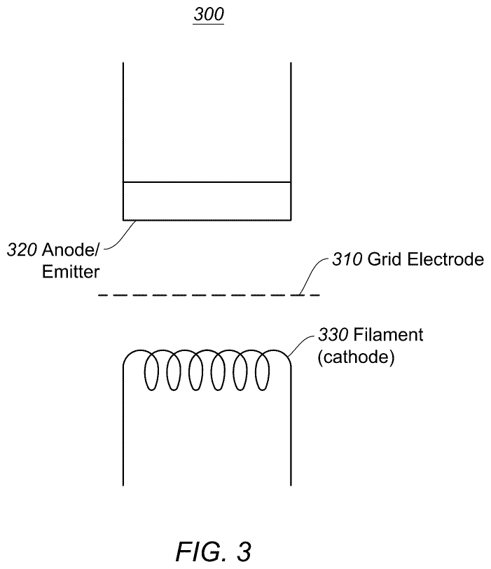

FIG. 3 illustrates a portion of an exemplary cathodoluminescent lamp 300 comprising a grid electrode 310 located between an anode 320 and a filament/cathode 330, in accordance with embodiments of the present invention.

Grid electrode 310 may comprise a metal and/or wire mesh, and may be wire shaped, and/or shaped as a ring and/or a flat coil. Grid electrode 310 acts to attract or repel electrons travelling between the cathode 330 and anode 320 of a cathodoluminescent lamp 300, in a manner similar to that of a triode vacuum tube. Operation of grid 310 allows beneficially improved control over the electron flow between cathode 330 and anode 320. Additionally, for this type of application, a bias applied to the grid 310 may be used to direct the electron flow resulting in better control of the area over which the electrons strike the anode 320, beneficially improving efficiency and lifetime.

In the interest of higher efficiency and longer lifetime, it is advantageous to control the distribution of the electrons striking the emitter, with a uniform distribution of electrons across the whole emitter surface being an ideal case.

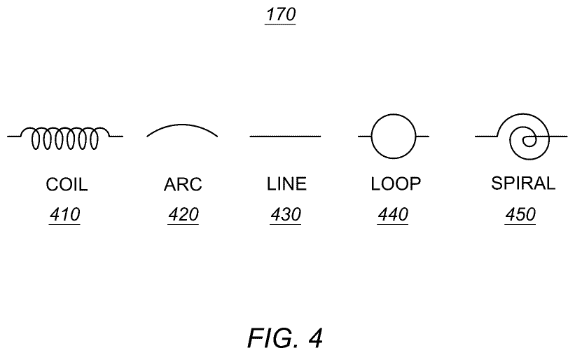

FIG. 4 illustrates several exemplary filament shapes, in accordance with embodiments of the present invention. The illustrated shapes may have advantageous electron distributions. Illustrated are a coil shape 410, an arc shape 420, a line shape 430, a loop shape 440, and a spiral shape 450.

The filament of the present invention needs to be electrically connected to the rest of the device, and this can be achieved in several possible ways. These can include a mechanical connection via, for example, small clips and/or mounting holes. The filaments can also be attached by the use of conductive adhesive or non-conductive adhesive if good electrical contact can be maintained. Additionally, spot welding or similar techniques can be used to directly join the filament to the filament contacts.

The filament of the present invention may operate, for example, at temperatures greater than 1800 K, e.g., around 2000 K, although this may vary considerably based on the filament material and design. The exterior of the device needs to be shielded from this high temperature, which is easily achieved by attaching the filament to appropriately designed contacts. Such contacts should be of a thermally conductive material, and can be designed to have sufficient mass to act as a heat sink for the filament. In accordance with embodiments of the present invention, the thermal mass of the contacts may be greater than ten times the thermal mass of the filament. In some embodiments, the thermal mass of the contacts may be greater than 100 times the thermal mass of the filament. In addition, the filament contacts should be good electrical conductors, and the combination of the thermal and electrical requirements suggests that aluminum, copper, or steel may be suitable materials for this component.

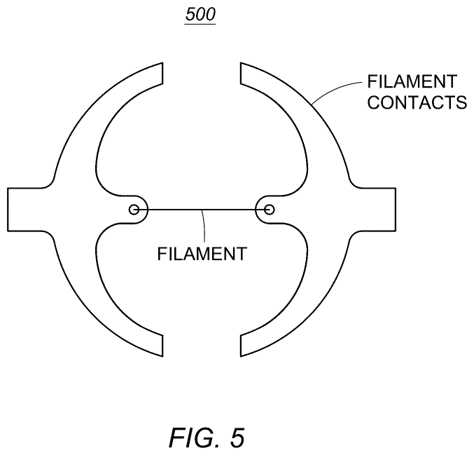

FIG. 5 illustrates an exemplary filament contact design 500, in accordance with embodiments of the present invention.

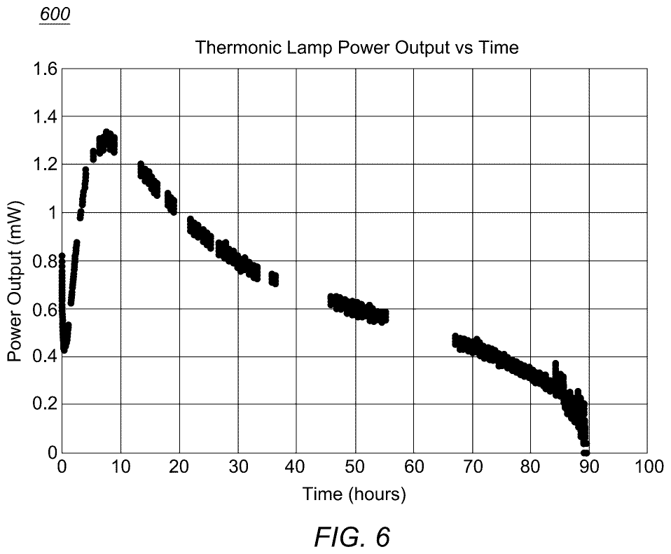

FIG. 6 illustrates an exemplary graph 500 of thermionic lamp output power vs. time, in accordance with embodiments of the present invention. The vertical axis indicates light power output at wavelengths of interest, e.g., 200-230 nm. Graph 500 reflects actual data from a prototype thermionic lamp, in accordance with embodiments of the present invention. Graph 500 indicates that lifetimes in excess of, for example, 50 hours or longer with desirable power outputs, e.g., greater than about 0.5 mW, or greater than about 0.1 mW are achievable with thermionic lamps in accordance with embodiments of the present invention. For example, embodiments in accordance with the present invention may operate for over 80 hours with a power output of at least 0.2 mW. (The gap(s) in the data are due to data collection issues, not alterations in lamp operation during testing. For example, the lamps were not stopped and started during such gap(s).)

It is appreciated that such demonstrated lifetimes are about an order of magnitude (or more) longer than lifetimes of convention art field-emission UV and/or far-UVC systems, e.g., lifetimes of about five hours or less.

One challenge encountered in the design of this device is the need for the cap to meet two possibly orthogonal design requirements. One requirement is that the cap be strongly reflective for the wavelengths of interest, e.g., 200-230 nm, while another requirement is that the coefficient of thermal expansion (CTE) of the cap needs to match that of the spacer tube, e.g., 240 (FIG. 2) as closely as possible. As previously presented, a good reflector for the wavelength range of interest is Aluminum, which has a CTE of 23.6e-6/C. As the CTE of borosilicate glass commonly used in practice for the spacer tube, e.g., 240, is 3.3e-6/C, aluminum is a poor thermal expansion match, and the joint between the cap and spacer tube may experience significant stress during thermal cycling.

Using a material such as Invar (CTE 1.6e-6/C), Kovar™ (CTE 5.1e-6/C), or 440 stainless steel (CTE 10.6e-6/C) will provide a better match to the borosilicate glass CTE, and improve the thermal stability of the connection between them.

In accordance with embodiments of the present invention, a cap, e.g., cap 230 as described in FIG. 2, may be formed from two pieces. This allows the emitter to be deposited directly onto an emitter platform with high reflectivity in the wavelength of interest while allowing the cap itself to be made from a material with a coefficient of thermal expansion more closely matched to the material of the spacer tube, although the cap material itself may be characterized as having poor reflectivity for the wavelength range of interest.

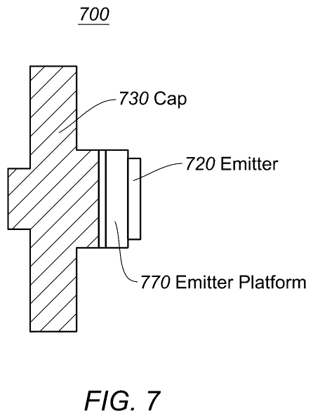

FIG. 7 illustrates a schematic diagram of an exemplary multi-piece cap structure 700, in accordance with embodiments of the present invention. Cap structure 700 is functionally similar to cap structure 230 of FIG. 2, e.g., cap structure 700 forms a part of a thermionic light emitting device.

In accordance with embodiments of the present invention, the emitter 720 is coated onto an emitter platform 770 comprising Aluminum. As previously presented, Aluminum has good reflectivity for the wavelengths of interest. However, Aluminum's coefficient of thermal expansion is much greater than that of a borosilicate glass spacer tube, e.g., spacer tube 240 (FIG. 2). The cap 730 may comprise stainless steel (or Kovar™, or Invar), which has a poor reflectivity for the emitted light but a coefficient of thermal expansion that more closely matches that of the glass spacer tube. The cap 730 and the emitter platform 770 may be joined together with a flexible material, e.g., Indium, that can accommodate any thermal strain between the cap 730 and the emitter platform 770. The cap 730 and the emitter platform 770 may also and/or alternatively be joined together by a robust mechanical connection such as a clamp or combination of shaft and set screw.

During operation of embodiments in accordance with the present invention, it is possible that the emitter, e.g., emitter 720 of FIG. 7, becomes hot, which may lower the efficiency of the emitter and result in a decreased power output for the lamp. To avoid this, it may be advantageous for the cap, e.g., cap 730 (FIG. 7), to act as a heat sink for the anode, and/or to add external thermal management components to the cap. Modifications to the cap design that may be helpful in managing heat may include increasing the mass of the cap, choosing a cap material with good thermal conductivity, and/or incorporating heat-dissipating structures, e.g., fins, into the design of the lamp. External thermal management components may include mountable heat sinks, e.g., fin arrays and/or fans.

Note that if the cap is made of multiple pieces, there should an efficient thermal coupling between the parts. This may be accomplished by direct metal-to-metal contact, e.g., avoiding an intervening adhesive, and/or by the use of a good thermal conductor as an adhesive, e.g., Indium or metal-based adhesives. There should also be a good electrical contact, e.g., a total of less than about 1 ohm, between the multiple pieces. If an adhesive is used between two components, then such adhesive should also be a good electrical conductor to maintain proper device operation.

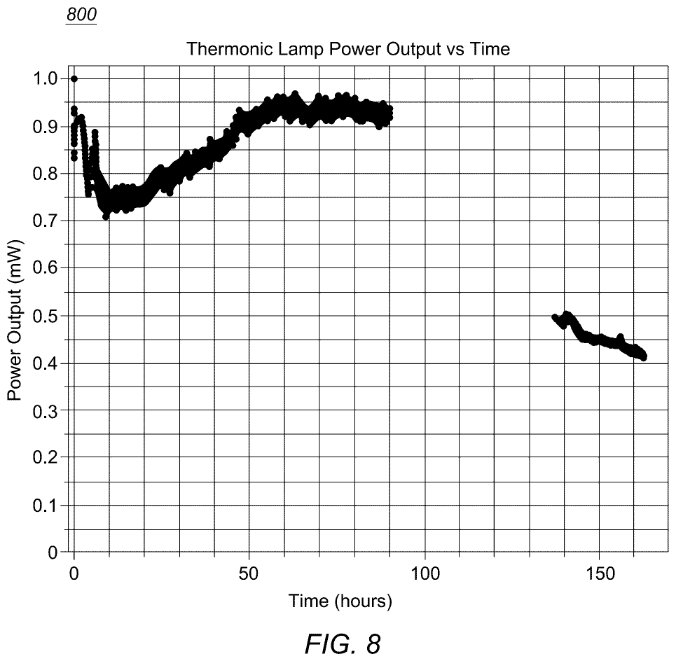

FIG. 8 illustrates an exemplary graph 800 of thermionic lamp output power vs. time, in accordance with embodiments of the present invention. The vertical axis indicates light power output at wavelengths of interest, e.g., 200-230 nm. Graph 800 reflects actual data from a prototype thermionic lamp, in accordance with embodiments of the present invention. Graph 800 indicates that lifetimes in excess of, for example, 130 hours or longer with desirable power outputs, e.g., greater than about 0.5 mW are achievable with thermionic lamps in accordance with embodiments of the present invention. For example, embodiments in accordance with the present invention may operate for over 130 hours with a power output of at least 0.4 mW. (The gap(s) in the data are due to data collection issues, not alterations in lamp operation during testing. For example, the lamps were not stopped and started during such gap(s).)

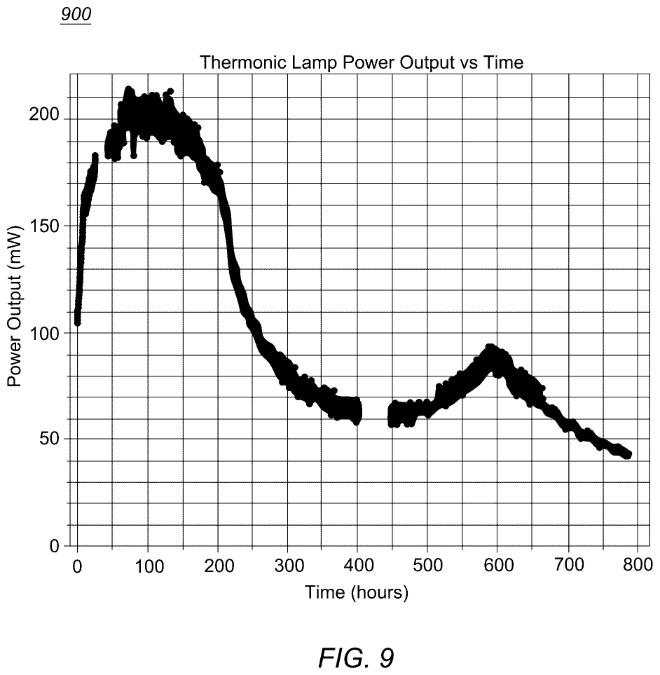

FIG. 9 illustrates an exemplary graph 900 of thermionic lamp output power vs. time, in accordance with embodiments of the present invention. The vertical axis indicates light power output at wavelengths of interest, e.g., 200-230 nm. Graph 900 reflects actual data from a prototype thermionic lamp, in accordance with embodiments of the present invention. Graph 800 indicates that lifetimes in excess of, for example, 700 hours or longer, with desirable power outputs, e.g., greater than about 50 μW, are achievable with thermionic lamps in accordance with embodiments of the present invention. (The gap(s) in the data are due to data collection issues, not alterations in lamp operation during testing. For example, the lamps were not stopped and started during such gap(s).)

Embodiments in accordance with the present invention provide cathodoluminescent materials that do not require the use of a field emitter type cathode. Embodiments in accordance with the present invention provide ultraviolet lamps based on cathodoluminescent material comprising an anode configured to reflect light from an emitter out of the device. Embodiments in accordance with the present invention provide ultraviolet lamps based on cathodoluminescent material comprising a vacuum envelope transparent to ultraviolet light. Embodiments in accordance with the present invention provide systems and methods for ultraviolet lamps based on cathodoluminescent material that are compatible and complementary with existing systems and methods of ultraviolet lamps. The lamps in accordance with aspects of the present invention can advantageously provide ultra-violet (UV) light that can be utilized to decontaminate, disinfect and the like, humans, vehicles and the like. The UV light can for example be utilized as a disinfectant in scientific applications. In other applications, the UV light can be utilized to decontaminate vehicles including but not limited to ambulances, firefighting apparatus, school buses, public transportation buses, private charter buses, trains, planes, ride shares and taxis.

The following examples pertain to specific embodiments and point out specific features, elements, or steps that may be used or otherwise combined in achieving such embodiments.

Example 1 includes a device, comprising: a filament, configured to emit electrons responsive to a voltage applied across the filament; an anode configured to receive electrons emitted from the filament; an emitter comprising cathodoluminescent material, disposed adjacent to the anode, configured to emit photons responsive to stimulation from the electrons, wherein the filament comprises a smooth emitting surface for emitting electrons; and a vacuum envelope configured to enclose the filament, anode, and emitter, and to maintain a vacuum over a path of the electrons.

Example 2 includes the device of Example 1 wherein the photons have a wavelength in a range of 200-230 nanometers (nm).

Example 3 includes the device of Example 1 wherein the anode is configured to reflect light from the emitter out of the device.

Example 4 includes the device of Example 1 wherein a portion of the vacuum envelope is transparent to the photons.

Example 5 includes the device of Example 1 configured to emit the photons though the same side as the filament.

Example 6 includes the device of Example 1 configured to apply a voltage of at least 1 kV between the anode and the cathode.

Example 7 includes the device of Example 1 wherein the filament is configured to operate at a temperature of greater than 1800 K.

Example 8 includes the device of Example 7 further comprising filament contacts, wherein the filament contacts comprise a thermally conductive material and have sufficient mass to act as a heat sink for the filament.

Example 9 includes the device of Example 1 wherein the emitter is coated upon the anode.

Example 10 includes the device of Example 1 further comprising a cap, configured to act as the anode, configured to physically support the emitter, and configured to reflect the photons.

Example 11 includes the device of Example 1 further comprising a control grid electrode disposed between the anode and the filament, configured to control a flow of electrons from the cathode to the anode.

Example 12 includes the device of Example 10 wherein the control grid is further configured to direct a flow of electrons to an area of the anode.

Example 13 includes the device of Example 1 further comprising a spacer tube configured to electrically insulate and physically separate the anode from the cathode, wherein the spacer tube is further configured to withstand a voltage greater than 1 kV.

Example 14 includes the device of Example 1 further comprising a faceplate forming at least a portion of the vacuum envelope, and wherein the faceplate is transparent to the photons.

Example 15 includes the device of Example 1 wherein the filament has a coil shape.

Example 16 includes the device of Example 1 wherein the filament has an arc shape.

Example 17 includes the device of Example 1 wherein the filament has a line shape.

Example 18 includes the device of Example 1 wherein the filament has a loop shape.

Example 19 includes the device of Example 1 wherein the filament has a spiral shape.

Example 20 includes the device of Example 1 wherein the filament has a circular cross section.

Example 21 includes the device of Example 1 wherein the anode comprises a first material in contact with the emitter, wherein the first material is characterized as having good reflectivity for wavelengths in the range of 200-230 nm, and wherein the first material is further characterized as having a coefficient of thermal expansion greater than that of a spacer tube coupled to the anode.

Example 22 includes the device of Example 21 wherein the anode comprises a second material in contact with the first material and not in contact with the emitter, wherein the second material is characterized as having poor reflectivity for wavelengths in the range of 200-230 nm, and wherein the second material is further characterized as having a coefficient of thermal expansion that more closely matches that of the spacer tube in comparison to the first material.

Example 23 includes the device of Example 22 wherein an electrical resistance between the first and second materials is less than about 1 ohm.

Example 24 includes the device of Example 23 wherein an adhesive coupling between the first and second materials is flexible, thermally conductive, and electrically conductive.

Example 25 includes a thermionic device, comprising a vacuum envelope, configured to emit photons outside of the vacuum envelope in the wavelength range of 200-230 nm.

Example 26 includes a light emitting device, configured to emit photons in the wavelength range of 200-230 nm from a solid state semiconductor, having a stable light emission of greater than or equal to 0.10 mW for more than 50 hours.

Example 27 includes a light emitting device, configured to emit photons in the wavelength range of 200-230 nm from a solid state semiconductor, having a stable light emission of greater than or equal to 0.50 mW for more than 130 hours.

Example 28 includes a light emitting device, configured to emit photons in the wavelength range of 200-230 nm from a solid state semiconductor, having a stable light emission of greater than or equal to 50 μW for more than 700 hours.

Example 29 includes a device for decontaminating a vehicle, comprising: a filament, configured to emit electrons responsive to a voltage applied across the filament; an anode configured to receive electrons emitted from the filament; an emitter comprising cathodoluminescent material, disposed adjacent to the anode, configured to emit photons responsive to stimulation from the electrons, wherein the filament comprises a smooth emitting surface for emitting electrons; and a vacuum envelope configured to enclose the filament, anode, and emitter, and to maintain a vacuum over a path of the electrons.

Example 30 includes the device of Example 29, wherein the vehicle is selected from a group consisting of an ambulance, a firefighting apparatus, a school bus, a public transportation bus, a private charter bus, a train, a plane, a ride share, and a taxi.

Example 31 includes a device configured for decontaminating in scientific applications, comprising: a filament, configured to emit electrons responsive to a voltage applied across the filament; an anode configured to receive electrons emitted from the filament; an emitter comprising cathodoluminescent material, disposed adjacent to the anode, configured to emit photons responsive to stimulation from the electrons, wherein the filament comprises a smooth emitting surface for emitting electrons; and a vacuum envelope configured to enclose the filament, anode, and emitter, and to maintain a vacuum over a path of the electrons.

Example 32 includes a light emitting device, configured to emit photons in the wavelength range of 200-230 nm from a solid state semiconductor, having a stable light emission of greater than or equal to 50 μW for more than 700 hours for decontaminating a vehicle.

Example 33 includes the device of Example 32, wherein the vehicle is selected from a group consisting of an ambulance, a firefighting apparatus, a school bus, a public transportation bus, a private charger bus, a ride share, and a taxi.

Example 34 includes a light emitting device, configured to emit photons in the wavelength range of 200-230 nm from a solid state semiconductor, having a stable light emission of greater than or equal to 50 μW for more than 700 hours for decontaminating in scientific applications.

Example 35 includes a device, comprising: a filament, configured to emit electrons responsive to a voltage applied across the filament; an anode configured to receive electrons emitted from the filament; an emitter comprising cathodoluminescent material, disposed adjacent to the anode, configured to emit photons responsive to stimulation from the electrons, wherein the filament comprises a smooth emitting surface for emitting electrons; and a vacuum envelope configured to enclose the filament, anode, and emitter, and to maintain a vacuum over a path of the electrons, while comprising at least one window material capable of transmitting the photons.

Although the subject matter has been described in language specific to a particular exemplary embodiment or embodiments and/or methodological acts, it is to be understood that the subject matter disclosed in the present disclosure is not necessarily limited to the specific features or acts described above. Rather, the specific features and acts described above are disclosed as exemplary forms of implementing the present disclosure. Equivalent alterations and modifications will occur to others skilled in the art upon the reading and understanding of this specification and the annexed drawings. In particular regard to the various functions performed by the above described components (assemblies, devices, etc.) the terms (including a reference to a “means”) used to describe such components are intended to correspond, unless otherwise indicated, to any component which performs the specified function of the described component (e.g., that is functionally equivalent), even though not structurally equivalent to the disclosed structure which performs the function in the herein illustrated exemplary embodiments of the invention. In addition, while a particular feature of the invention may have been disclosed with respect to only one of several embodiments, such feature may be combined with one or more features of the other embodiments as may be desired and advantageous for any given or particular application.

Embodiments according to the invention are thus described. While the present disclosure has been described in particular embodiments, the invention should not be construed as limited by such embodiments, but rather construed according to the following claims.

1. A device, comprising:
a filament, configured to emit electrons responsive to a voltage applied across the filament;
an anode configured to receive electrons emitted from the filament;
an emitter comprising cathodoluminescent material, disposed adjacent to the anode, configured to emit photons responsive to stimulation from the electrons,
wherein the filament comprises a smooth emitting surface for emitting electrons; and
a vacuum envelope configured to enclose the filament, anode, and emitter, and to maintain a vacuum over a path of the electrons, while comprising at least one window material capable of transmitting the photons.

2. The device of claim 1 wherein the photons have a wavelength inclusive of a range of 200-230 nanometers (nm).

3. The device of claim 1 wherein the anode is configured to reflect light from the emitter out of the device.

4. The device of claim 1 wherein a portion of the vacuum envelope is transparent to the photons.

5. The device of claim 1 configured to emit the photons though the same side as the filament.

6. The device of claim 1 configured to apply a voltage of at least 1 kV between the anode and the cathode.

7. The device of claim 1 wherein the filament is configured to operate at a temperature of greater than 1800 K.

8. The device of claim 7 further comprising filament contacts, wherein the filament contacts comprise a thermally conductive material and have sufficient mass to act as a heat sink for the filament.

9. The device of claim 1 wherein the emitter is coated upon the anode.

10. The device of claim 1 further comprising a cap, configured to act as the anode, configured to physically support the emitter, and configured to reflect the photons.

11. The device of claim 1 further comprising a control grid electrode disposed between the anode and the filament, configured to control a flow of electrons from the cathode to the anode.

12. The device of claim 10 wherein the control grid is further configured to direct a flow of electrons to an area of the anode.

13. The device of claim 1 further comprising a spacer tube configured to electrically insulate and physically separate the anode from the cathode, wherein the spacer tube is further configured to withstand a voltage greater than 1 kV.

14. The device of claim 1 further comprising a faceplate forming at least a portion of the vacuum envelope, and wherein the faceplate is transparent to the photons.

15. The device of claim 1 wherein the filament has a shape selected from a group consisting of a coil shape, an arc shape, a line shape, a loop shape, and a spiral shape.

16. The device of claim 1 wherein the filament has a circular cross section.

17. The device of claim 1 wherein the anode comprises a first material in contact with the emitter,
wherein the first material is characterized as having good reflectivity for wavelengths in the range of 200-230 nm, and
wherein the first material is further characterized as having a coefficient of thermal expansion greater than that of a spacer tube coupled to the anode.

18. The device of claim 17 wherein the anode comprises a second material in contact with the first material and not in contact with the emitter,
wherein the second material is characterized as having poor reflectivity for wavelengths in the range of 200-230 nm, and
wherein the second material is further characterized as having a coefficient of thermal expansion that more closely matches that of the spacer tube in comparison to the first material.

19. The device of claim 18 wherein an electrical resistance between the first and second materials is less than about 1 ohm.

20. The device of claim 19 wherein an adhesive coupling between the first and second materials is flexible, thermally conductive, and electrically conductive.

21. A thermionic device, comprising a vacuum envelope, configured to emit photons outside of the vacuum envelope in the wavelength range of 200-230 nm.

22. A light emitting device, configured to emit photons in the wavelength range of 200-230 nm from a solid state semiconductor, having a stable light emission of greater than or equal to 50 μW for more than 700 hours.
